(19) United States
(12) Patent Application Publication
(10) Pub. No.: US 2015/0325856 A1
(43) Pub. Date: Nov. 12, 2015

(54) ENVIRONMENTALLY FRIENDLY INKJET-PRINTABLE LITHIUM BATTERY CATHODE FORMULATIONS, METHODS AND DEVICES

(71) Applicant: NEW JERSEY INSTITUTE OF TECHNOLOGY, Newark, NJ (US)

(72) Inventors: John Federici, Westfield, NJ (US); Yuan Gu, Kearny, NJ (US); Aide Wu, Kearny, NJ (US)

(21) Appl. No.: 14/687,881

(22) Filed: Apr. 15, 2015

Related U.S. Application Data
(60) Provisional application No. 61/979,892, filed on Apr. 15, 2014.

(51) Int. Cl. H01M 4/58; H01M 4/04; H01M 4/62

(52) U.S. Cl. CPC H01M 4/5825; H01M 4/622; H01M 4/0402

(57) ABSTRACT

Inkjet-printable formulations of cathode materials, such as lithium phosphates with olivine structure such as but not limited to LiFePO₄ are disclosed. The ink is formulated using an environmentally friendly process, which uses water as the solvent for the cathode's binder.

### CROSS-REFERENCE TO RELATED APPLICATIONS

This application claims the benefit of U.S. Provisional Patent Application Ser. No. 61/979,892 filed Apr. 15, 2014, the entirety of which is incorporated herein by reference.

### FEDERALLY SPONSORED RESEARCH

This invention was made with government support under grant and/or contract W15QKN-10-D-0503 awarded by the United States Army (ARDEC, Picatinny Arsenal). Therefore, the government has certain rights in the invention.

### FIELD OF THE INVENTION

The present invention relates to the field of lithium batteries; more specifically, the fabrication of water based cathodes by inkjet printing for environmentally friendly lithium batteries.

### BACKGROUND OF THE INVENTION

Lithium ion batteries are a type of rechargeable (secondary) battery in which lithium ions move from the negative electrode to the positive electrode during discharge and back when charging. Lithium ion batteries are a promising energy storage system for laptop computers, tablets, mobile devices, hybrid electric vehicles, plug-in hybrid electric vehicles, and other such things. Lithium ion batteries are light, compact, and work with a voltage of the order of 4V with a specific energy ranging between 100 Whkg⁻¹ and 150 Whkg⁻¹. Lithium ion batteries are expected to provide an energy return factor higher than that assured by conventional batteries, such as lead acid batteries.

Lithium metal batteries can be either disposable (primary) or rechargeable (secondary). Typically, they exhibit a long life and a specific energy around 200 Whkg⁻¹. Lithium metal batteries are typically used in applications requiring long life, such as implanted medical devices. Lithium batteries also can be mechanically flexible, for use with flexible and portable electronic equipment, such as flexible displays, wearable electronic devices, implanted medical devices, and micro-vehicles (both land and air). Flexible batteries are typically fabricated as thin flat sheets, enabling the batteries to conform to odd shapes, which creates a range of possibilities for product designers. For instance, flexible batteries can be used for electronically controlled drug delivery systems and wearable medical sensors wrapped around a wrist, arm, or other body part. Moreover, a thin flexible battery sheet can be rolled up into a tube and inserted into a tubular framework of a briefcase handle or a wheelchair, as a small portable power source for electronic devices or sensors. Flexible batteries are also being used in the next generation of credit cards and security cards, known as “smart cards” or “powered cards,” which utilize the batteries to power embedded memory chips or microprocessors. Flexible batteries are further being used to power Radio Frequency Identification sensory devices by providing local power for the integrated sensors.

Lithium metal and ion batteries are more costly than other batteries, and the chemicals used in the fabrication of such lithium batteries are toxic and dangerous. Thus, there is a need for a low cost, environmentally friendly lithium battery and a method of producing such lithium batteries.

### SUMMARY OF THE INVENTION

The present invention relates to inkjet-printable formulations of cathode materials, such as lithium phosphates with olivine structure, such as but not limited to LiFePO₄. The ink is formulated using an environmentally friendly process, which uses water as the solvent for the cathode's binder. The cathode material is inkjet printed and may be characterized using a scanning electron microscope and x-ray diffraction.

In one embodiment an inkjet-printable formulation suitable for a cathode material includes LiMPO₄ nanoparticles wherein M is a transition metal and a binder comprising carboxymethylcellulose (CMC). The formulation may include one or more of a conductive agent, a surfactant and a pH regulator. In some embodiments the formulation has a pH in the range of from 6 to 10. In other embodiments the formulation has a pH of 8 to 10. In other embodiments the formulation has a pH of 8.5 to 9.5. In other embodiments the pH of the formulation is 9.

Methods are disclosed for making an inkjet-printable cathode formulation which involves combining CMC with a stoichiometric amount of LiMPO4 nanoparticulate powder wherein M is a transition metal, a conductive agent, a surfactant and a pH value regulator, wherein the pH value is in the range of from 6 to 10. In other embodiments the formulation has a pH of 8 to 10. In other embodiments the formulation has a pH of 8.5 to 9.5. In other embodiments the pH of the formulation is 9.

In a still further embodiment methods of forming a cathode for a flexible battery are disclosed, which methods involve applying a formulation including LiMPO4 nanoparticles wherein M is a transition metal and a binder comprising carboxymethylcellulose (CMC) by inkjet printing on a substrate. The method may include heating the substrate to 40° C. In another embodiment the method may include applying multiple layers of the formulation to the substrate.

In a further embodiment, flexible batteries including a cathode material including LiMPO4 nanoparticles wherein M is a transition metal and a binder comprising carboxymethylcellulose (CMC) are disclosed.

### BRIEF DESCRIPTION OF THE DRAWINGS

So that those having ordinary skill in the art will have a better understanding of how to make and use the disclosed systems and methods, reference is made to the accompanying figures wherein:

FIG. 1 depicts the scheme of a common lithium ion battery;

FIGS. 2(a)-2(d) are graphical depictions of electrochemical properties of different binders in a TiO₂ anode and LiNi_{1/3}Mn_{1/3}CO_{1/3}O₂ cathode materials; FIGS. 2(a) and 2(b) indicate that replacing PVDF binder with CMC yields superior coulombic efficiency and specific capacity with charging/discharging cycling; FIGS. 2(c) and 2(d) indicate recharging improvements for various levels of charging/discharging rate;

FIG. 3(a) depicts a flexible lithium battery structure according to an embodiment of the present invention;

FIG. 3(b) depicts an exploded view of a flexible lithium battery according to an embodiment of the present invention;

FIG. 3(c) depicts a visible image of an inkjet printed LFP/CMC binder cathode with patterned structure according to an embodiment of the present invention;

FIG. 3(d) depicts an additional visible image of an inkjet printed LFP/CMC binder cathode with patterned structure according to an embodiment of the present invention;

FIG. 3(e) depicts x-ray diffraction data from the cathode according to an embodiment of the present invention shows characteristic peaks of pure LFP indicating that no significant contaminants were introduced by ink formulation or by an inkjet printing process;

FIG. 4(a) is a graphical representation of Fe and Li ion concentration as a function of initial pH values according to an embodiment of the present invention;

FIG. 4(b) is a graphical depiction of the evolution of inks of several embodiments of the invention pH as a function of aging time (A: initial pH=3.0, B initial pH=5.0, C initial pH=7.0, D initial pH=9.0, E, initial pH=10.0);

FIG. 5 depicts particle size evolution of ink prepared with different initial pH values according to an embodiment of the present invention;

FIG. 6 depicts XRD patterns of embodiments of the present invention in different initial pH conditions after the ink dried according to an embodiment of the present invention;

FIG. 7 depicts photographic images of embodiments of the present invention with ink prepared with different initial pH values after 48 h(left) and dried inks (right); and

FIG. 8 is a graphical depiction of the initial charge/discharge capacity of different embodiments of the present invention (A: initial pH=3.0, B: initial pH=5.0, C: initial pH=7.0, D: initial pH=9.0, E, initial pH=10.0).

### DETAILED DESCRIPTION OF THE INVENTION

The following is a detailed description of the invention provided to aid those skilled in the art in practicing the present invention. Those of ordinary skill in the art may make modifications and variations in the embodiments described herein without departing from the spirit or scope of the present invention. Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. All publications, patent applications, patents, figures and other references mentioned herein are expressly incorporated by reference in their entirety.

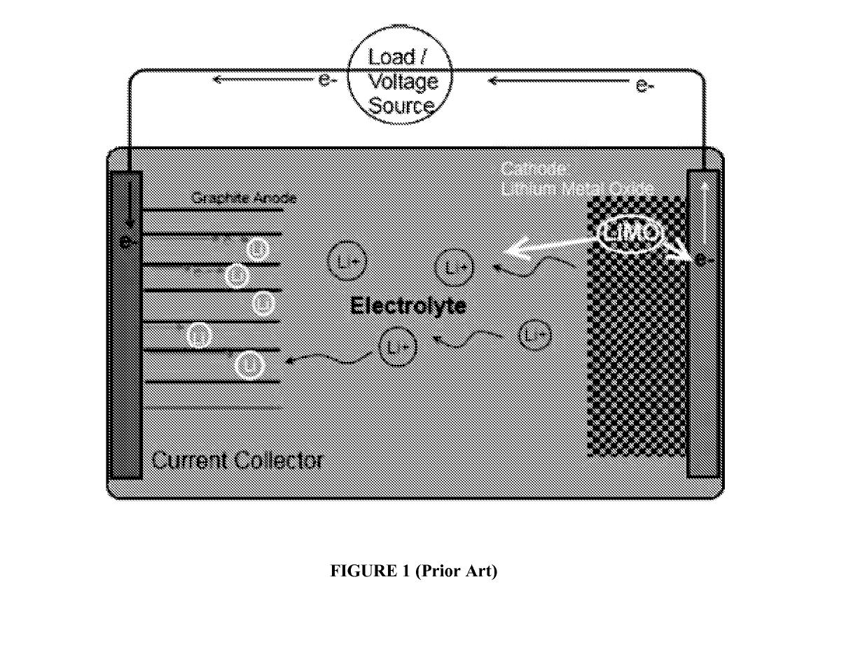

FIG. 1 shows a prior art lithium ion battery containing a cathode, an anode, and an electrolyte. The cathode is formed by a lithium metal oxide or phosphate, while the anode is typically a graphite electrode. The electrolyte is typically a lithium salt such as LiPF₆ dissolved in an organic solvent such as ethylene carbonate. The anode material is deposited on a copper current collector while the cathode material is deposited on an aluminum current collector.

In embodiments disclosed herein, flexible battery structures are provided which are safer and more flexible compared with traditional batteries as show in FIG. 1. Lithium ion battery cathodes disclosed herein employ water-based ink formulations which are printable and environment friendly. “Green” cathode materials used are water-based inks which replace the chemically toxic organic system currently used. Using inkjet printing techniques disclosed herein, flexible batteries can be made thinner than conventional batteries.

For the positive cathode materials in one embodiment of the present invention, lithium phosphates (LiMPO₄ (M=transition metals)) with olivine structure are used in the application of lithium batteries. The olivine structured polyanion phosphate, LiFePO₄ (LFP) is a naturally occurring mineral and has a number of notable advantages when used as a cathode in lithium batteries. Benefits include but are not limited to stable thermodynamic properties, reliable working performance, non-toxicity, environmental friendliness, easily acquired composition of elements, low cost, stable charge-discharge plateau, and high specific capacity and specific power. LFP materials are suitable for applications requiring high safety, high cycle life, high power, and low costs.

TABLE 1

| | LiCoO₂ | LiNiO₂ | LiMn₂O₄ | LiFePO₄ |
|---|---|---|---|---|
| Theoretical | 274 | 274 | 148 | 170 |
| Capacity (mAh/g) | | | | |
| Practical | 120-155 | 135-180 | 100-130 | 100-160 |
| Capacity | | | | |
| Rate Capability | Good | Medium | Poor | Poor |
| Cycle Life | Good | Good | Fair | Good |
| Operating | 3.9 | 3.8 | 4.1 | 3.4 |
| Voltage (vs. | | | | |
| Li/Li+) | | | | |
| High | Good | Good | Poor | Good |
| Temperature | | | | |
| Property | | | | |
| Thermal Stability | Poor | Very Poor | Good | Good |
| Density (g/cm³) | 5.1 | 4.8 | 4.2 | 3.6 |
| Environment | Toxic | Toxic | Green | Green |
| Cost ($/kg) | 25 | 13 | 0.5 | 0.23 |
| Synthesis | Easy | Hard | Tricky | Hard |

Table 1 shows properties of a number of possible positive cathode materials. While the LFP cathode material does not have as high of a theoretical capacity of energy storage per unit weight as some other materials, its practical capacity is comparable to or exceeds other materials. The LFP cathode material properties at high temperatures are comparable. Of particular note are the minimum environmental impact and low cost compared to other materials. LFP suffers from poor electronic and ionic conductivity as well as slow Li+ ion diffusion in its structure during redox reaction, but these drawbacks are minimized by using better methods of synthesizing including use of conductive coating and ionic substitution to enhance electrochemical properties.

Lithium battery cathode materials of one embodiment of the present invention include a binder, which serves two primary functions. The binder holds the active materials and conductive agent into a cohesive, conductive film, and the binder holds together the conductive film and current collector. Polyvinylidene fluoride (PVDF) has conventionally been employed as the binder for electrodes in lithium batteries, due primarily to its electrochemical stability over a large voltage range. However, PVDF is insoluble in water, so slurries are prepared industrially with an organic solvent, such as N-methyl-pyrrolidone (NMP). NMP, while an excellent solvent for PVDF, is dangerous to humans and the environment, as shown by Table 2.

TABLE 2

| Parameter | Toxicity Value* | Reference |
|---|---|---|
| Oral LD₅₀ (rats, | 3900-7900 mg/kg | Ansell and Fowler, |
| mice, guinea-pigs | (Tox. Cat. III-IV) | 1988, as cited |
| and rabbits) | | in WHO 2001 |
| Dermal LD₅₀ | 4000-10,000 mg/kg | Bartsch et al., |
| (rats and rabbits) | (Tox. Cat. III-IV) | as cited |
| | | in WHO 2001; |
| | | Wallen 1992 |
| Inhalation LC₅₀ (rats; | >5.1 mg/L | BASF, 1988, |
| heads only) | (5100 mg/m³) | as cited |
| | (Tox. Cat. IV) | in WHO 2001 |
| Inhalation LC₅₀ (rats; | =1.7 mg/L | E. I. DuPont de |
| whole body | (1700 mg/m³) | Nemours & Co. |
| exposure) | (Tox. Cat. III) | 1977, as cited |
| | | in WHO 2001 |
| Primary Eye | Moderate (causing | Ansell and Fowler, |
| Irritation (rabbits) | corneal opacity, iritis | as cited |
| | and conjunctivitis); | in WHO 2001 |
| | recovered after 21 | |
| | days post dosing | |
| Primary Skin | Practically non- | Ansell and Fowler, |
| Irritation (rabbits) | irritating | as cited |
| | | in WHO 2001 |

Furthermore, using PVDF as a binder for lithium batteries requires a process of recovery and treatment for the organic vapors. The NMP solvent or other organic systems are flammable, which increases dangers during electrode fabrication and means strict control is required for safety. Humidity is another problem for organic solvent systems, which requires severe water control systems leading to higher costs. Fluorine in PVDF itself can lead to problems as well. Fluorine is one of the degradation products in the battery that produces a stable LiF phase. Certain liquid electrolytes could accelerate the formation reaction of LiF and other harmful products with double bond (C═CF—). Also, fluorine can induce self-heating thermal runway. Lastly, PVDF has strong binding but low flexibility, which lowers its applicability as a flexible power source. The low flexibility can additionally deteriorate the battery's cycle life characteristics due to breaking of the mechanical bond between active materials during an expansion/contraction process which occurs during charging and discharging.

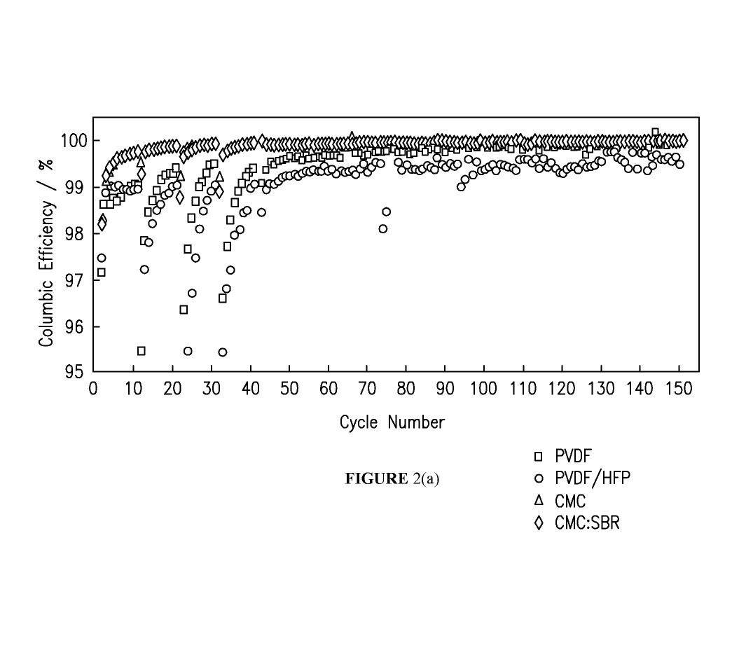

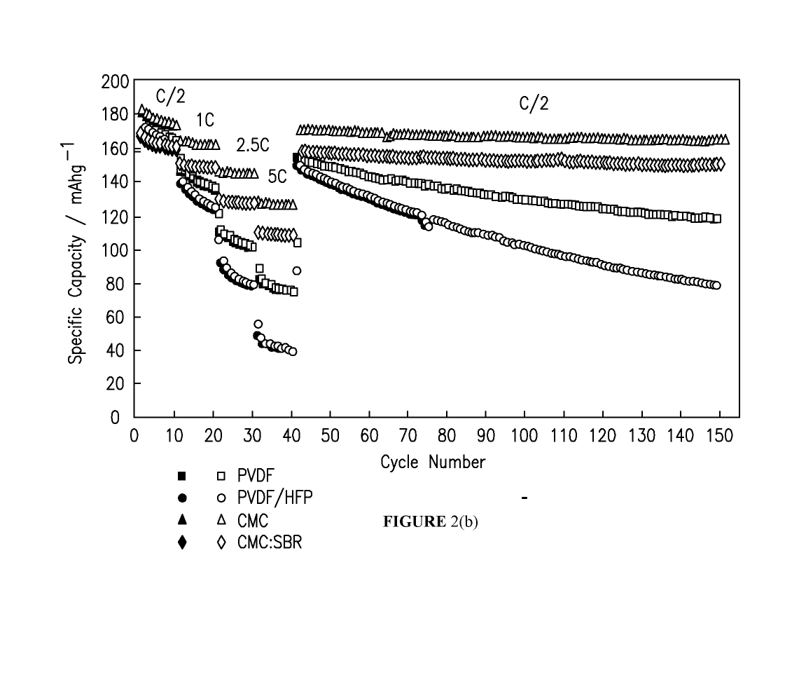

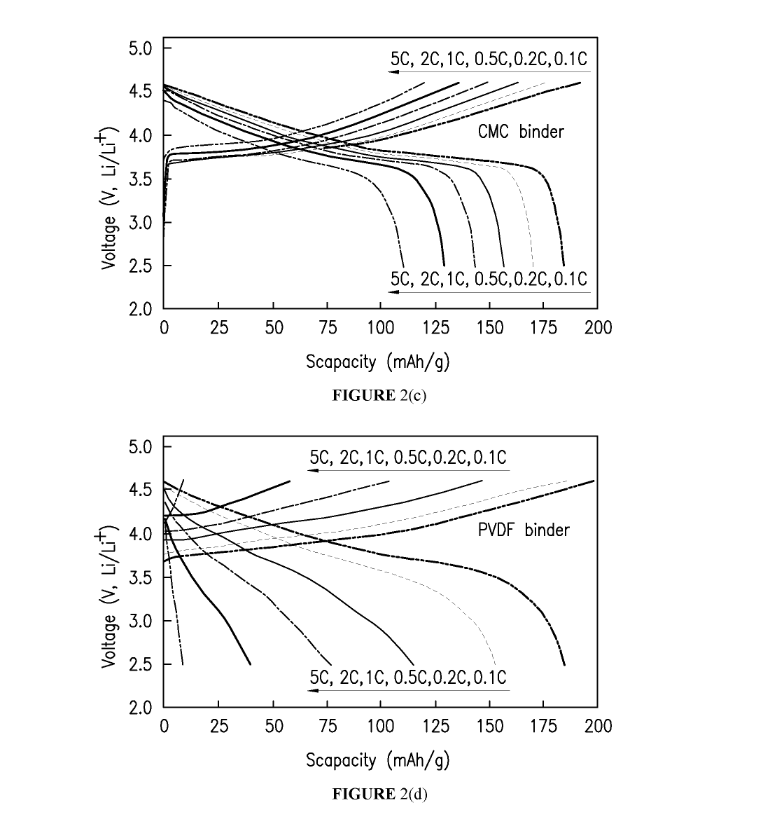

Because of the above issues with organic systems for cathode fabrication, one embodiment of the present invention uses an aqueous route for battery fabrication by eliminating the waste stream for the organic system and using sodium carboxymethyl cellulose (CMC) as the binder. CMC can easily dissolve in water and has several significant advantages compared with PVDF in an organic system. Advantages include but are not limited to: (1) low cost, (2) no treatment of organic vapors, (3) environmentally friendly since the organic solvents are replaced by water as the solvent, (4) enhancement of active material ratio in a cell owing to reduction of binder content, (5) no requirement for strict control of processing humidity, (6) fast and simple drying in electrode fabrication, (7) improved mechanical properties, which can extend the cycle life of batteries, and (8) no degradation of products as has been demonstrated with a TIO₂ anode and LiNi_{1/3}Co_{1/3}O₂ cathode. With reference to FIGS. 2(a)-2(d), the CMC binder has better cycle properties compared to a PVDF binder. Specifically, FIGS. 2(a) and 2(b) indicate that replacing the PVDF binder with CMC yields superior coulombic efficiency and specific capacity with charging/discharging cycling. FIGS. 2(c) and 2(d) indicate recharging improvements for various levels of charging/discharging rate.

One embodiment of the present invention is an environmentally friendly fabrication process for the cathode structure of LFP battery fabrication. Instead of an organic solvent and PVDF binder, an environmentally friendly water based processing with CMC as the binder is used. Further, the LFP cathode fabrication is adapted for inkjet printing. The LFP materials processing is modified to form smaller nanoparticles of LFP. Inkjet printing is a cost effective fabrication method for flexible electronics.

LFP ink preparation of one embodiment of the present invention starts with a suspension media of dissolved amounts of CMC in deionized (DI) water, where concentration ranges from about 5 g to about 10 g per 10 ml. By varying the concentration of CMC, viscosity of a dispersion media can be changed. Dissolution of CMC takes about 10 hours at around 50° C. with a magnetic stirrer. After dissolution, a stoichiometric amount of LFP powder, a conductive agent (such as carbon black), a surfactant (such as Triton X100), and a pH value regulator (such as monoethanolamine) are added using a bath sonication to disperse the mixture for about 30 minutes, where the pH values range from about 6 to about 10.

A cartridge (such as a 10 picoliter DMP-2800 series cartridge from Fujifilm) is used to inkjet print on a suitable substrate the LFP ink according to embodiments of the present invention. In some embodiments, drop spacing may be set as approximately 25 μm, a cleaning process may execute every 10 bands, and a voltage applied on printing nozzles may be about 25V. In some embodiments, to ensure quality printed patterns, a substrate is heated up to 40° C. to accelerate evaporation of water in the ink. A deposition of electrode material is done by about 20-30 layers of inkjet printing. This novel formulation extends the shelf time of water-based LFP ink over what is currently available.

Cathode current collectors may be any suitable material known to those skilled in the art. The cathode may be printed on the current collector in some embodiments. It will be apparent to those skilled in the art the novel cathodes may be employed in connection with any suitable flexible battery design. Such flexible batteries may employ any suitable substrate such as but not limited to film, foil, fabric, paper, etc. The anode may be formed of any suitable material known to those skilled in the art. The separator may be any suitable material such as but not limited to polypropylene, polyethylene, etc.

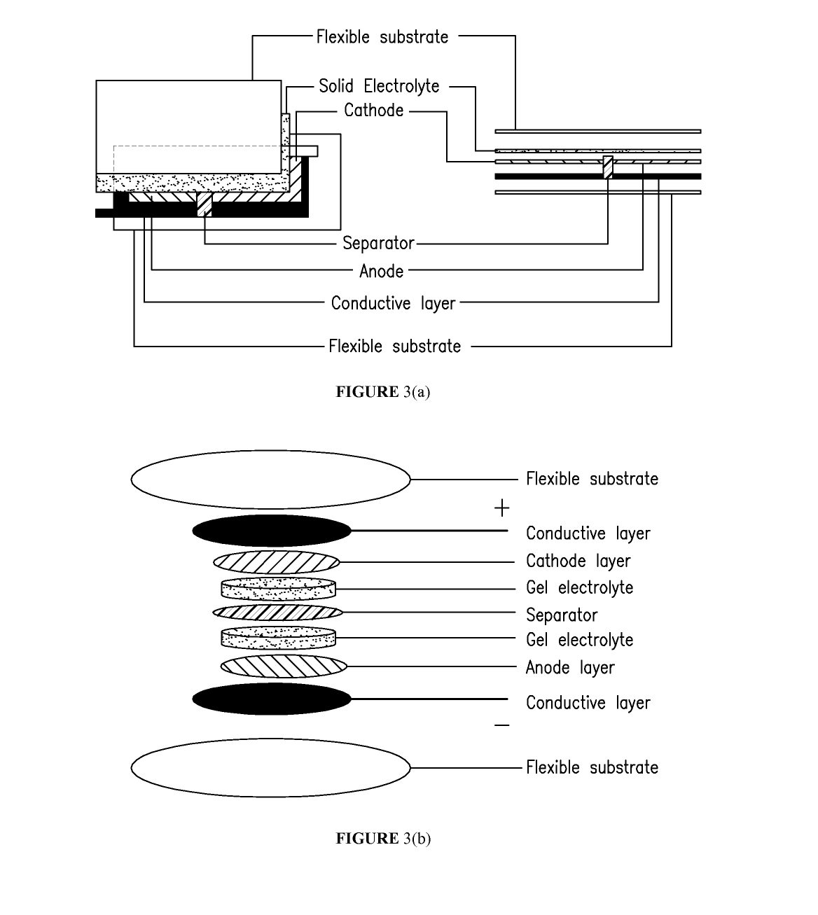

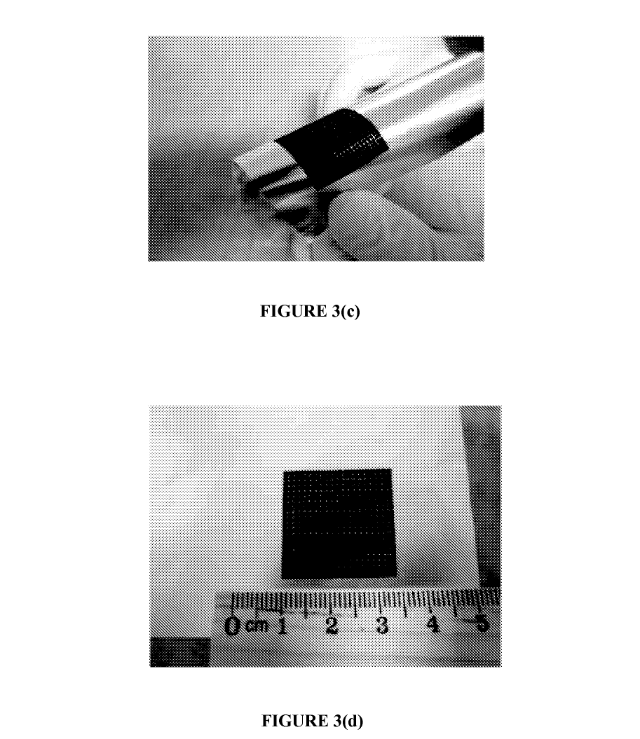

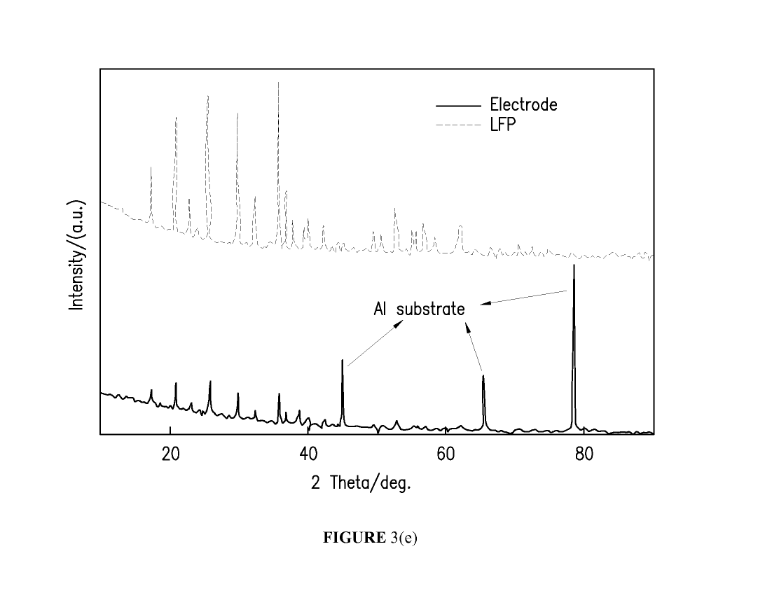

Now referring to FIGS. 3(a) and 3(b), exemplary embodiments of a flexible battery with water-based LFP and CMC binder formulation in inkjet printed form are shown. In the embodiment of FIG. 3(a) a flexible battery includes successive layers of a top flexible substrate layer disposed on a solid electrolyte, which is disposed on a cathode. A separator is disposed between the cathode and an anode. A bottom flexible substrate layer includes a conductive layer disposed thereon.

In the embodiment of FIG. 3(b) a flexible battery includes, in succession, a top flexible substrate layer, a conductive layer, a cathode layer, a gel electrolyte layer, a separator, a further gel electrolyte layer, an anode layer, a further conductive layer and a bottom flexible substrate layer.

With further reference to FIGS. 3(c) and 3(d), an actual inkjet printed LFP/CMC binder cathode with patterned structure is shown. The inkjet-printed LFP/CMC cathode may be patterned as shown to minimize material fatigue of the cathode during charging/discharging of the battery. The cathode has excellent mechanical flexibility. With reference to FIG. 3(e), X-ray diffraction (XRD) characterization of the LFP cathode after printing show characteristic peaks of pure LFP indicating that no significant contaminants were introduced by the ink formulation or by the inkjet printing process.

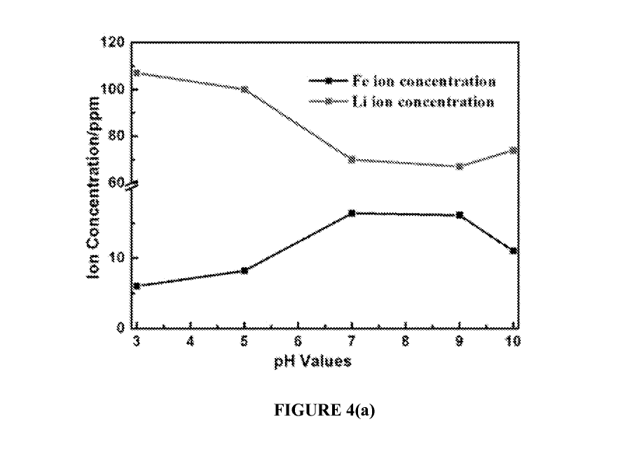

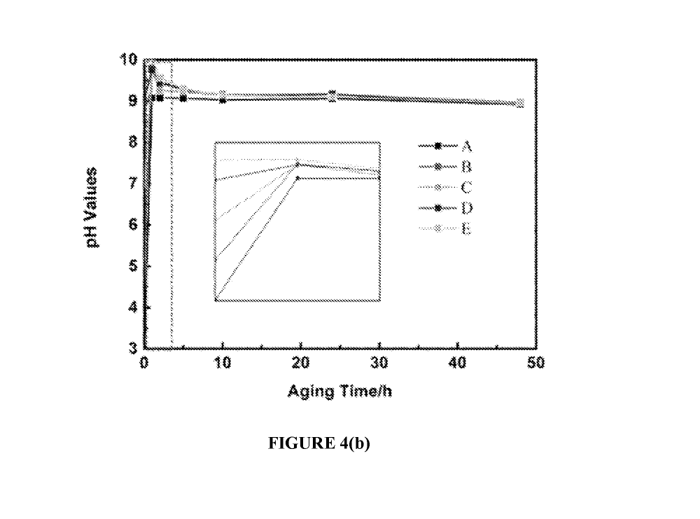

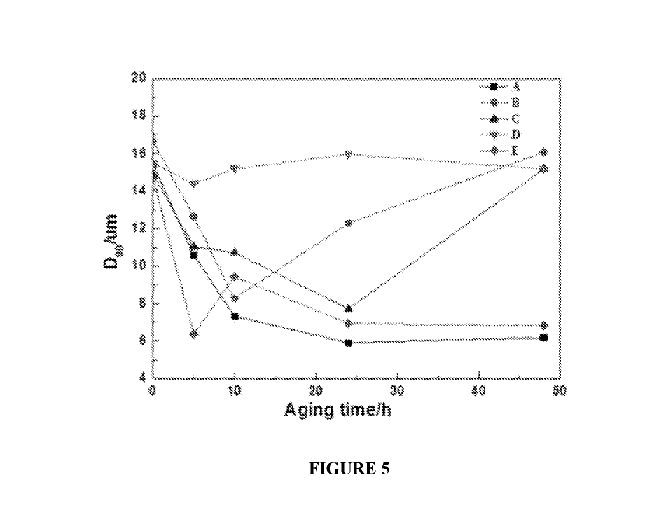

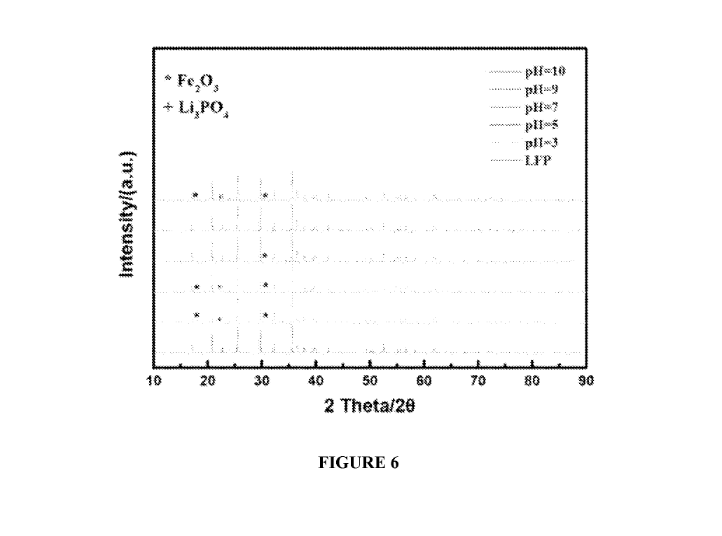

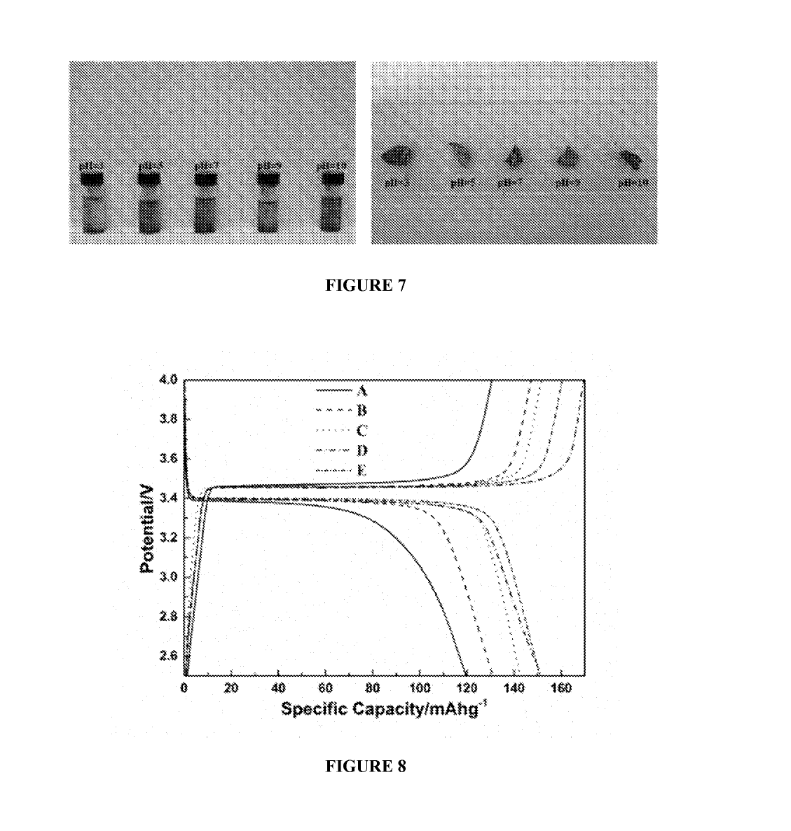

To get LiFePO₄ materials into a form suitable for ink jet printing, small nanoparticles of LiFePO₄ are needed. To keep particles from agglomerating and therefore getting above the size necessary for incorporation in the ink of the present invention pH must be closely controlled. In one embodiment of the present invention initial pH is 9.0. This pH value correlates to the amount of dissolved LFP being the lowest compared with other samples indicating small individual nanoparticle size without any nanoparticle agglomeration or other defects to the ink solution. To evaluate the effect of initial pH value on the particle size, particle analysis was performed by using laser particle analyzer. Now referring to FIG. 4(a), ion concentrations of Fe and Li were plotted for a range of pH values. FIG. 4(b) shows pH changes over time of various inks subjected to testing. The data, along with the data in FIG. 5, indicate the embodiment of the present invention with an initial pH=9.0 had the smallest particle size distribution (D90) and the particle size could maintain the same distribution state after certain aging time. Together with the XRD results shown in FIG. 6, it is clear that the dissolved LFP will increase the aggregation of particles in the form of impurities which was identified by white color. From FIG. 7, it is clear that the LFP powder in pH=9.0 condition still maintains a typical LFP color, however, for the other LFP samples, it can be observed that there are different degrees of white colored substance, which are correlated with XRD results, indicating the existence of impurities. As a very important property, the electrochemical properties of embodiments of the present invention were prepared with different initial pH conditions and said embodiments were tested by assembling type-2012 coin batteries. The charging and discharging rate is 0.1 C which is generally agreed to investigate the intrinsic property, the results shown in FIG. 8. It is clear that the initial pH=9.0 sample bears the best performance.

Although the systems and methods of the present disclosure have been described with reference to exemplary embodiments thereof, the present disclosure is not limited thereby. Indeed, the exemplary embodiments are implementations of the disclosed systems and methods are provided for illustrative and non-limitative purposes. Changes, modifications, enhancements and/or refinements to the disclosed systems and methods may be made without departing from the spirit or scope of the present disclosure. Accordingly, such changes, modifications, enhancements and/or refinements are encompassed within the scope of the present invention. All references listed and/or referred to herein are incorporated by reference in their entireties.

### REFERENCES

[1] Electrical Power Storage Technologies for Alternative Energy Sources, BCC Research 2011.
[2] B. Scrosati, J. Garche, Lithium batteries: Status, prospects and future, Journal of Power Sources, 195(2010) 2419-30.
[3] Global Battery Markets, 2011.
[4] H. Nishide, K. Oyaizu, Toward flexible batteries, Science, 319(2008) 737-8.
[5] M. Rivera, Current and Next-Generation Energy Storage Devices for Micro Vehicle Applications, SAE International Journal of Materials and Manufacturing, 5(2012) 19-29.
[6] M. Jacoby, Batteries Get Flexible, Chemical & Engineering News, 91(2013) 13-8.
[7] Flexsion Batteries, Solicore, Inc. 2013.
[8] d.l. Casas, Charles, L. Wenzhi, A review of application of carbon nanotubes for lithium ion battery anode material, Journal of Power Sources, 208(2012) 74-85.
[9] J. H. Lee, J. S. Kim, Y. C. Kim, D. S. Zang, U. Paik, Dispersion properties of aqueous-based LiFePO4 pastes and their electrochemical performance for lithium batteries, Ultramicroscopy, 108(2008) 1256-9.
[10] A. K. Padhi, K. S. Nanjundaswamy, J. B. Goodenough, Phospho-olivines as Positive-Electrode Materials for Rechargeable Lithium Batteries, J Electrochemical Soc, 144(1997) 1188-94.
[11] H. Peng, J. Tang, J. Pang, D. Chen, L. Yang, H. S. Ashbaugh, et al., Polydiacetylene/Silica Nanocomposites with Tunable Mesostructure and Thermochromatism from Diacetylenic Assembling Molecules, J Am Chem Soc, 127(2005) 12782-3.
[12] J. Chong, S. Xun, H. Zheng, X. Song, G. Liu, P. R. e. al, A comparative study of polyacrylic acid and poly(vinylidene difluoride) binders for spherical natural graphite/LiFePO4 electrodes and cells, Journal of Power Sources, 196(2011) 7707-14.
[13] U.s.e.p. agency, (2006).
[14] A. Guerfi, M. Kaneko, M. Petitclerc, M. Mori, K. Zaghib, LiFePO4 water-soluble binder electrode for Li-ion batteries, Journal of Power Sources, 163(2007) 1047-52.
[15] Hossein Maleki, Guoping Deng, Inna Kerzhner-Haller, Anaba Anani, a. J. N. Howard, Thermal Stability Studies of Binder Materials in Anodes for Lithium-Ion Batteries, Journal of The Electrochemical Society, 147(2000) 4470-5.
[16] D. J., G. M., D. R., P. F. W., M. M., P. S., et al., Cellulose as a binding material in graphitic anodes for Li ion batteries: a performance and degradation study, Electrochimica Acta, 48(2003) 883-9.
[17] Z. Wang, N. Dupré, A.-C. Gaillot, B. Lestriez, J.-F. Martin, L. Daniel, et al., CMC as a binder in LiNi0.4Mn1.6O4 5&#xa0; V cathodes and their electrochemical performance for Li-ion batteries, Electrochimica Acta, 62(2012) 77-83.
[18] J. Xu, S.-L. Chou, Q.-f. Gu, H.-K. Liu, S.-X. Dou, The effect of different binders on electrochemical properties of LiNi1/3Mn1/3Co1/3O2 cathode material in lithium ion batteries, Journal of Power Sources, 225(2013) 172-8.
[19] A. Moretti, G.-T. Kim, D. Bresser, K. Renger, E. Paillard, R. Marassi, et al., Investigation of different binding agents for nanocrystalline anatase TiO2 anodes and its application in a novel, green lithium-ion battery, Journal of Power Sources, 221(2013) 419-26.
[20] F. Xu, T. Wang, W. Li, Z. Jiang, Preparing ultra-thin nano-MnO2 electrodes using computer jet-printing method, Chem Phys Lett, 375(2003) 247-51.
[21] H. Xia, L. Lu, G. Ceder, Substrate effect on the microstructure and electrochemical properties of LiCoO2 thin films grown by PLD, J Alloys Compd, 417(2006) 304-10.
[22] F. Nobili, S. Dsoke, M. Minicucci, F. Croce, R. Marassi, Correlation of Ac-Impedance and In Situ X-ray Spectra of LiCoO2, The Journal of Physical Chemistry B, 110(2006) 11310-3.
[23] M. Nishizawa, T. Uchiyama, T. Itoh, T. Abe, I. Uchida, Electrochemical Quartz Crystal Microbalance for Insertion/Extraction of Lithium in Spinel LiMn2O4 Thin Films, Langmuir, 15(1999) 4949-51.
[24] H.-S. Moon, J.-W. Park, Improvement of cyclability of LiMn2O4 thin films by transition-metal substitution, J Power Sources, 119-121(2003) 717-20.
[25] F. Michalak, K. von Rottkay, T. Richardson, J. Slack, M. Rubin, Electrochromic lithium nickel oxide thin films by RF-sputtering from a LiNiO2 target, Electrochim Acta, 44(1999) 3085-92.
[26] M. Yoshimura, K.-S. Han, S. Tsurimoto, Direct fabrication of thin-film LiNiO2 electrodes in LiOH solution by electrochemical-hydrothermal method, Solid State Ionics, 106(1998) 39-44.

What is claimed is:

1. An inkjet-printable formulation suitable for a cathode material comprising LiMPO₄ nanoparticles wherein M is a transition metal and a binder comprising carboxymethylcellulose (CMC).

2. The invention of claim 1 wherein M is Fe.

3. The invention of claim 1 further comprising a conductive agent, a surfactant and a pH regulator.

4. The invention of claim 1 wherein the pH of the formulation is in the range of from 6 to 10.

5. The invention of claim 1 wherein the pH of the formulation is in the range of from 8 to 10.

6. The invention of claim 1 wherein the pH of the formulation is in the range of from 8.5 to 9.5.

7. The invention of claim 1 wherein the pH of the formulation is 9.

8. A method of making an inkjet-printable cathode formulation comprising combining CMC with a stoichiometric amount of LiMPO₄ nanoparticulate powder wherein M is a transition metal, a conductive agent, a surfactant and a pH value regulator, wherein the pH value is in the range of from 6 to 10.

9. The invention of claim 8 wherein M is Fe.

10. The invention of claim 8 wherein the pH of the formulation is in the range of from 8 to 10.

11. The invention of claim 8 wherein the pH of the formulation is in the range of from 8.5 to 9.5.

12. The invention of claim 8 wherein the pH of the formulation is 9.

13. A method of forming a cathode for a flexible battery, comprising applying a formulation comprising LiMPO₄ nanoparticles wherein M is a transition metal and a binder comprising carboxymethylcellulose (CMC) by inkjet printing on a substrate.

14. The method according to claim 13 comprising heating the substrate to 40° C.

15. The method according to claim 13 comprising applying multiple layers of the formulation to the substrate.

16. A flexible battery comprising a cathode material comprising LiMPO4 nanoparticles wherein M is a transition metal and a binder comprising carboxymethylcellulose (CMC).

17. The invention of claim 16 wherein M is Fe.
